(19) United States
(12) Patent Application Publication
(10) Pub. No.: US 2012/0016604 A1
(43) Pub. Date: Jan. 19, 2012

(54) Methods and Systems for Pointing Device Using Acoustic Impediography

(75) Inventors: Richard Irving, Palm Beach Gardens, FL (US); Omid S. Jahromi, Palm Beach Gardens, FL (US); Ronald A. Kropp, West Palm Beach, FL (US); Rainer M. Schmitt, Palm Beach Gardens, FL (US)

(73) Assignee: Sonavation, Inc., Palm Beach Gardens, FL (US)

(21) Appl. No.: 13/108,566

(22) Filed: May 16, 2011

Related U.S. Application Data
(60) Provisional application No. 61/334,895, filed on May 14, 2010.

(51) Int. Cl. G06F 19/00

(52) U.S. Cl. 702/56

(57) ABSTRACT

Invention includes a novel pointing device which uses acoustic impediography as a means to locate the position of finger and then uses the said location to control the position of a cursor on a computer screen. In addition, while the finger is touching the sensor the touch-pressure level can be estimated via statistical data evaluation, as average brightness decreases with increasing touch-pressure providing a means for gesturing. This new device has the advantage that it can double as a biometric identification device for verifying the identity of the computer's user.

### CROSS-REFERENCE TO RELATED APPLICATIONS

This application claims benefit to U.S. Provisional Application No. 61/334,895, filed on May 14, 2010, which is incorporated herein by reference.

### BACKGROUND OF THE INVENTION

1. Field of the Invention

The present invention relates to human interface devices. More specifically, the present invention relates to using an acoustic impediography device to control the position of a cursor or pointer on a computer screen.

2. Background Art

In computer technology, a pointing device is a human interface device that allows a user to input spatial data to a computer. Many computer applications especially those that utilize Graphical User Interfaces (GUI) allow the user to control and provide data to the computer using physical gestures. These gestures (point, click, and drag, for example) are produced by moving a hand-held mouse across the surface of the physical desktop and activating switches on the mouse. Movements of the pointing device are echoed on the screen by movements of the pointer (or cursor) and other visual changes.

While the most common pointing device by far is the mouse, it is not always possible to use a mouse device to position the cursor. Hand-held computers, personal digital assistants (PDA) and “smart phones” are examples of computer systems where it is not feasible to use a conventional mouse device due to size and other physical restrictions. In these situations, it is preferable to use a more compact pointing device such as a track ball or touchpad.

A touchpad is a human interface device (HID) consisting of a specialized surface that can translate the motion and position of a user's finger(s) to a relative position on screen. Modern touchpads can also be used with stylus pointing devices and those powered by infrared do not require physical touch, but just recognize the movement of hand and fingers in some minimum range distance from the touchpad's surface. Touchpads have become increasingly popular with the introduction of palmtop computers, laptop computers, mobile smartphones (like the iPhone sold by Apple, Inc.), and the availability of standard touchpad device drivers into Symbian, Mac OS X, Windows XP and Windows Vista operating systems. These existing touchpads, however, are unable to provide an identity of the user.

What are needed, therefore, are methods and systems to overcome the deficiencies noted above of existing touchpads systems.

### BRIEF SUMMARY OF EMBODIMENTS OF THE INVENTION

Embodiments of the present invention overcome the aforementioned deficiencies by providing a novel pointing device which uses acoustic impediography as a means to locate the position of finger and then uses the said location to control the position of a cursor on a computer screen. In addition, while the finger is touching the sensor the touch-pressure level can be estimated via statistical data evaluation, as average brightness decreases with increasing touch-pressure providing a means for gesturing. This new device has the advantage that it can double as a biometric identification device for verifying the identity of the computer's user. Combining identity verification and pointing functionalities in one compact device can have great advantages in portable computer systems or smart phone devices where size is a limiting constraint.

More particularly, embodiments of the present invention include measuring the shape and the location of a person's fingertip impression on an array of acoustic sensors. In one embodiment, two consecutive arrays of impedance measurements are obtained. These two arrays are then processed using mathematical cross-correlation analysis to compute a possible shift associated with the position of a human finger touching the sensor.

In another embodiment, the impedance measurements are transformed to the frequency domain using Fourier Transform. Specific characteristics of Fourier Transform phase are then used to measure how much the location of the finger has shifted on the acoustic array. This latter approach is conceptually different from and often superior to the shift detection method based on cross-correlation analysis.

Further embodiments, features, and advantages of the present invention, as well as the structure and operation of the various embodiments of the present invention are described in detail below with reference to accompanying drawings.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is an exemplary sensor constructed in accordance with embodiments of the present invention.

### DETAILED DESCRIPTION OF THE INVENTION

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

As noted above, embodiments of the present invention include an improved sensing device that is based on the concept of surface acoustic impediography. This improved device can be used to sense biometric data, such as fingerprints. The sensor maps the acoustic impedance of a biometric image, such as fingerprint pattern, by estimating the electrical impedance of a large number of small sensing elements. The sensing elements, which are made of a special piezoelectric compound, can be fabricated inexpensively at large scales and can provide a resolution, by way of example, Of up to 50 μm over an area of 20 by 25 square millimeters.

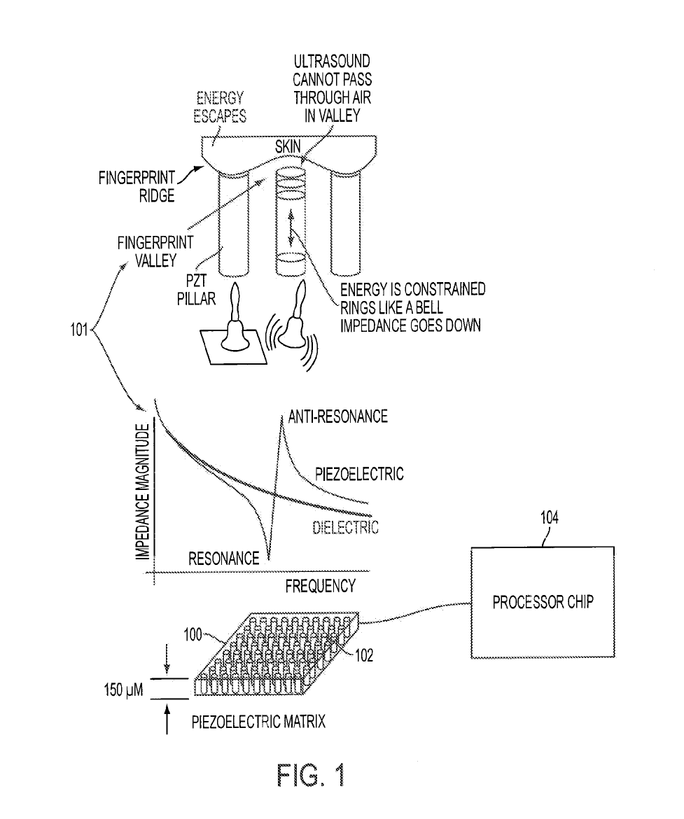

FIG. 1 is an exemplary sensor 100 constructed in accordance with embodiments of the present invention. Principles of operation 101 of the sensor 100 are also shown. Sensing elements 102 are connected to an electronic processor chip 104. This chip converts the electric impedance of each of the sensing elements 102 and converts it to an 8-bit binary number between 0 and 255. The binary numbers associated with all the sensing elements in the sensor are then stored in a memory device as an array of numbers. The processor chip 104 repeats this process every T microseconds. Therefore a change in the surface acoustic impedance of an object touching the sensor can be measured at detected at regular time intervals.

Let u(n, m) represent an N by M array of binary numbers associated with the acoustic impedance measurement obtained by the sensor at time T₀ and let v(n, m) represent a second array of binary numbers obtained by measuring the surface acoustic impedance of the sensor at a later time T₁. In the preceding notation, the first argument n represents the index of the sensing elements in the horizontal direction and the second argument m represents the index of sensing elements in the vertical direction. Thus, n=1, 2, 3, . . . , N and m=1, 2, 3, . . . , M.

In a first embodiment of the invention, a shift in the location of the finger on the sensor surface is detected by calculating the cross correlation function shown in the formula below:

$$C ( p , q ) = \frac{{\sum }_{m , n} u ( n , m ) v ( ( n - p ) , ( m - q ) )}{\sqrt{{\sum }_{m , n} {u ( n , m )}^{2} \times {\sum }_{m , n} {v ( n , m )}^{2}}}$$

The above formula is calculated for various values of the parameters p and q. The specific values of p and q that lead to the maxim value for C(p, q) will represent the amount of shift (in the horizontal and vertical directions, respectively) in the location of the finger on the sensor surface.

The above procedure is repeated every time the acoustic sensor measures a new array of numbers associated with the surface acoustic impedance of the finger touching its surface. This way, potentially new values for p and q which indicate a potential shift in the position of the finger on the sensor are obtained every T microseconds. These values are sent to a control module which uses this information to control the location of a pointer or cursor on the computer screen.

In a second embodiment of the invention, the shift in the position of the finger on the sensor is calculated using the Phase Transform. In this case, the number arrays u(n, m) and v(n, m) are first converted to two number arrays U(ωₙ, ωₘ) and V(ωₙ, ωₘ) using a procedure known as two-dimensional Discrete Fourier Transform (DFT). This procedure is familiar to those skilled in the science of digital signal processing. The new arrays U(ωₙ, ωₘ) and V(ωₙ, ωₘ) are complex-valued meaning that each array entry has amplitude and phase components. We discard the amplitude components and use the mathematical notation Φ(ωₙ, ωₘ) and Ψ(ωₙ, ωₘ) to represent the phase component of the complex arrays U(ωₙ, ωₘ) and V(ωₙ, ωₘ), respectively. The PHAse Transform method uses these two latter arrays to estimate the shift in the location of the finger on the acoustic sensor. This is done by first calculating the following integral or an approximation to it:

$$D ( p , q ) = {\int \int }_{{ω}_{n} , {ω}_{m}} cos ( p {ω}_{n} + q {ω}_{m} - Φ ( {ω}_{n} , {ω}_{m} ) + Ψ ( {ω}_{n} , {ω}_{m} ) ) d {ω}_{n} d {ω}_{m}$$

The above integral is calculated for various values of the parameters p and q. The specific values of p and q that lead to the maxim value for D(p, q) represent the estimated amount of shift (in the horizontal and vertical directions, respectively) in the location of the finger on the sensor surface.

As was done in the first embodiment, the above procedure is repeated every time the acoustic sensor measures a new array of numbers associated with the surface acoustic impedance of the finger touching its surface. This way, potentially new values for p and q which indicate a potential shift in the position of the finger on the sensor are obtained every T microseconds. These values are then sent to a control module which uses this information to control the location of a pointer or cursor on the computer screen.

A great advantage of the PHAse Transform over the cross-correlation method described in the first embodiment is its robustness to noise and a variety of other artifacts that affect the amplitude of the acoustic surface impedance values measured by the sensor. Also, it is very easy to use the Phase Transform formula above for calculating fractional (i.e. non-integer) shifts.

In addition to navigating into the x- and y-direction a touch pressure level (relative) is obtained simultaneously from the actual values of the impedance of the fingertip area in contact with the sensors active surface. This pressure level estimate can be utilized to trigger further activities such as adjusting levels, switching on and off etc.

A low touch pressure provides fewer ridges in contact with the sensor which is reflected by a higher score for average brightness while higher pressure leads firstly to more ridges in contact with the sensor and secondly to wider ridges as they become more flattened by the touch-pressure. Both factors decreases the total score of average brightness. the difference between both values is utilized as a switch or as a sliding scale for pressure. Individual difference in average brightness are compensated by short calibration procedure where a soft and hard touch of the respective fingertip is taken.

### CONCLUSION

Example embodiments of the methods, systems, and components of the present invention have been described herein. These example embodiments have been described for illustrative purposes only, and are not limiting. Other embodiments will be apparent to persons skilled in the relevant art(s) based on the teachings contained herein.

1. A gesturing device, comprising:
a touch pad for providing a command for a computer based upon movement of a biometric image; and
a sensor electrically coupled to the touch pad, the sensor configured for sensing acoustic impedance of the biometric image;
wherein the acoustic impedance is used to interpret a direction of the movement and identify a user.
